(19) United States
(12) Patent Application Publication
(10) Pub. No.: US 2025/0026276 A1
(43) Pub. Date: Jan. 23, 2025

(54) ACCESS DOOR WITH VIRTUAL HINGE ARRANGEMENT

(71) Applicant: INTERNATIONAL AUTOMOTIVE COMPONENTS GROUP NA, INC., Southfiled, MI (US)

(72) Inventors: Joseph ZHU, Pudong, Shanghai (CN); Zokan CHEN, Pudong, Shanghai (CN); Changbo LIU, Pudong, Shanghai (CN); James YU, Pudong, Shanghai (CN)

(21) Appl. No.: 18/714,120

(22) PCT Filed: Nov. 29, 2022
(86) PCT No.: PCT/US2022/080530

§ 371 Date: May 29, 2024

Related U.S. Application Data
(60) Provisional application No. 63/283,591, filed on Nov. 29, 2021.

(51) Int. Cl. B60R 7/04; E05D 15/50

(52) U.S. Cl. CPC B60R 7/04; E05D 15/502; E05Y 2900/538

(57) ABSTRACT

A hinged access door that can rotatably open in two different directions based on a user selection to provide access to a storage compartment, and more preferably, a storage compartment within a vehicle.

### TECHNICAL FIELD

This specification relates to a hinged access door that can rotatably open in two different directions based on a user selection to provide access to a storage compartment, and more preferably, a storage compartment within a vehicle.

### BACKGROUND INFORMATION

The following is not an admission that anything discussed below is part of the prior art or part of the common general knowledge of a person skilled in the art.

Vehicle storage compartments, such as those located between a driver seat and front-side passenger seat, can include access doors that can slide, rotate, or otherwise open to permit user access. Some such vehicle access doors can include a spring-loaded lock mechanism that includes an unlock button that, when actuated by a user, causes the access door to unlock and swing/rotate open. However, this may result in the access door opening along a rotational path that provides convenient access to the driver, for instance, but obstructs access by the front-side passenger. In addition, the unlock button may be located at a position which is inconvenient to reach by the driver and/or passenger.

### BRIEF DESCRIPTION OF THE DRAWINGS

These and other features advantages will be better understood by reading the following detailed description, taken together with the drawings wherein:

The drawings included herewith are for illustrating various examples of articles, methods, and apparatuses of the teaching of the present specification and are not intended to limit the scope of what is taught in any way.

FIG. 1 shows an example access door consistent with aspects of the present disclosure.

FIG. 2 shows a top view of the access door of FIG. 1, in accordance with aspects of the present disclosure.

FIG. 3 shows a perspective view of the access door of FIG. 1, in accordance with aspects of the present disclosure.

FIG. 4 shows another top view of the access door of FIG. 1, in accordance with aspects of the present disclosure.

FIG. 5 shows another perspective view of the access door of FIG. 1, in accordance with aspects of the present disclosure.

FIG. 6A shows an enlarged section of the access door of FIG. 1 in accordance with aspects of the present disclosure.

FIG. 6B shows the enlarged section of FIG. 6A after actuation of a button by a user.

FIG. 7 shows an exploded view of the access door of FIG. 1 in accordance with aspects of the present disclosure.

### DETAILED DESCRIPTION

As discussed above, there exists a need for access doors in vehicles that can be rotatably opened in multiple different directions to provide a user with access to a storage compartment.

In view of the foregoing, an access door is disclosed herein that implements a virtual hinge arrangement to allow a user to select between two different rotation paths for opening of the access door. Preferably, the access door is implemented within a vehicle such as an automobile to provide access to a vehicle storage compartment. The virtual hinge arrangement preferably includes first and second locking arrangements disposed within a body of the access door, and more preferably, within the body of the access door on opposite sides in a parallel relationship.

The first and second locking arrangements each further preferably include a locking arm that can be transitioned between a locked orientation and an unlocked orientation. In the locked orientation, each locking arm includes an end that couples to a locking section/portion provided by a support structure that underlies the access door. Preferably the support structure is implemented as a Y-shaped structure (See FIG. 5) such as a yoke that provides two locking posts/lobes that extend at least partially into the body of the access door for coupling to the locking arms. When both locking arms are in the locked orientation, the access door is in the closed position and preferably prevents user access to the associated storage compartment.

On the other hand, either locking arm can transition to the unlocked orientation to decouple from the locking section of the support structure. Preferably, the access door includes a plurality of buttons at an end, with each button coupled to an associated locking arm. Each button is further preferably configured to receive user input and cause actuation of an associated locking arm, and thus by extension, the transition between the locked and unlocked orientation.

Preferably, the side of the access door having the locking arm in the unlocked orientation may then rotate about the axis of rotation provided by the other locking arm, i.e., the locking arm in the locked orientation. This preferably includes a spring bias to assist rotational movement of the access door such that user force is optional to bring the access door to the open position. This rotation of the access door is therefore preferably achieved by the locking arm that remains coupled to the support structure via the locking section, i.e., the locking arm that is in the locked orientation. Thus, the locking arm in the locked orientation can provide a so-called “virtual” hinge about which the access door can rotate for opening purposes. The opposite locking arm, which is in the unlocked orientation, then preferably becomes a latch for the access door. A user may then close the access door by supplying a force on to the access door in order to cause rotation of the door and engagement of the latch with the locking structure, e.g., to transition the locking arm to the locked orientation once again.

The term “virtual hinge arrangement” in the context of an access door refers to a mechanical arrangement with locking arms that can operate either as a latch to securely couple an access door to a support structure, or as a hinge that provides an axis of rotation about which the access door can rotate to open. Therefore, a virtual hinge means a mechanical assembly that can operate as a hinge when desired, or as a latch to allow for removable coupling to a support structure.

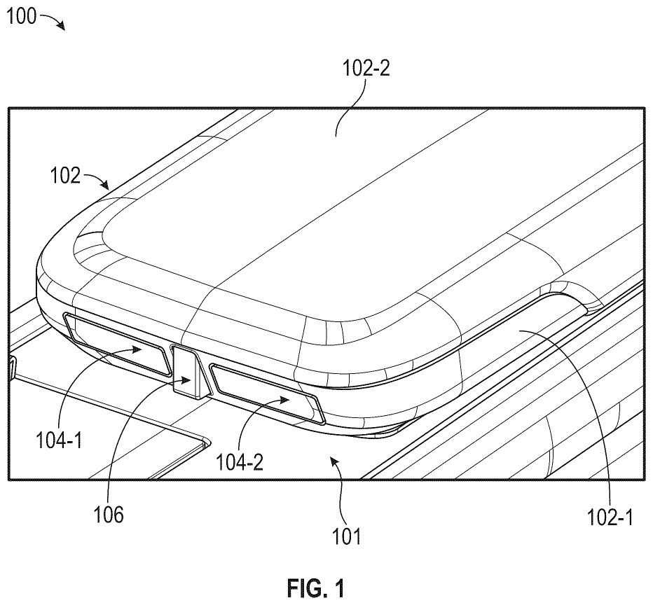

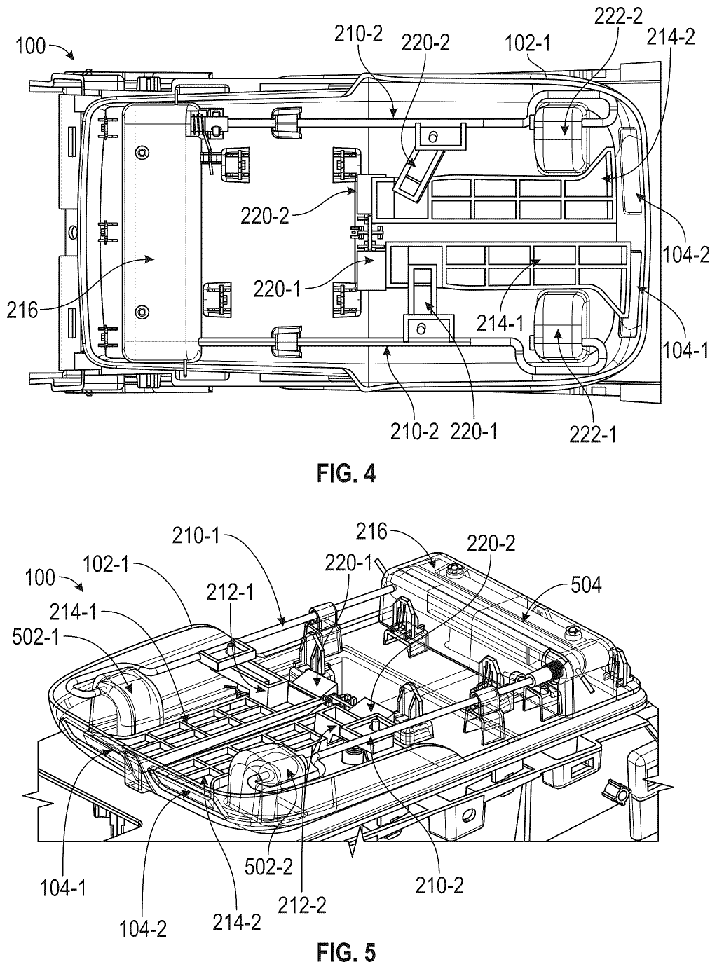

Referring to FIGS. 1-7, an example access door 100 for use within a vehicle is disclosed. The access door 100 may also be referred to herein as a hinged access door. Preferably, the access door 100 provides at least a portion of an armrest within a vehicle, although disclosure is not limited in this regard.

As shown, the access door 100 preferably includes a body shown collectively at 102 and individually as first and second body portions 102-1 and 102-2. The body 102 is preferably formed from a material such as a polymer, although other types of materials are within the scope of this disclosure.

The body 102 is preferably configured to couple to a support structure, such as support structure 101 of a vehicle. In one preferred example, the support structure 101 is implemented as a center section of a vehicle that is disposed between the driver seat and front-row passenger seat. However, this disclosure is not limited in this regard and an access door consistent with the present disclosure may be utilized in other locations such as between second-row passenger seats.

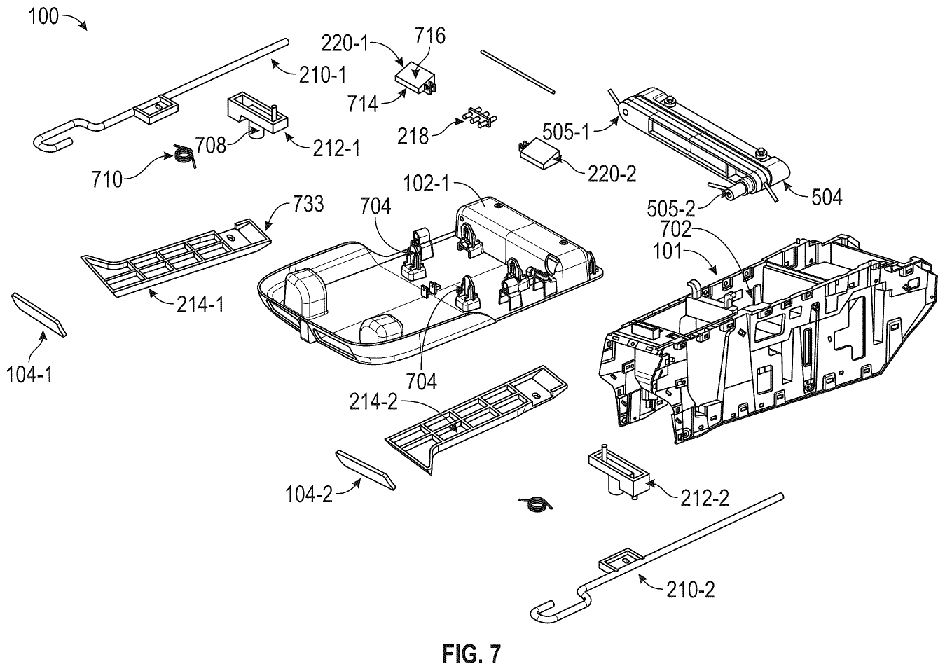

The support structure 101 further preferably defines at least one storage compartment, such as storage compartment 702 (See FIG. 7). The body 102 is preferably configured to rotatably couple to the support structure 101 and transition between a closed position which at least partially prevents access to the corresponding storage compartment, and an open position which allows for a user to access the corresponding storage compartment to place/retrieve items therein. Stated differently, the body 102 of the access door 100 is preferably configured to removably cover the storage compartment. As discussed further below, the body 102 is preferably configured to allow a user to selectively cause the body 102 to rotate open in one of two different directions to, for instance, allow for vehicle occupants disposed on either side of the access door 100 to conveniently access the corresponding storage compartment.

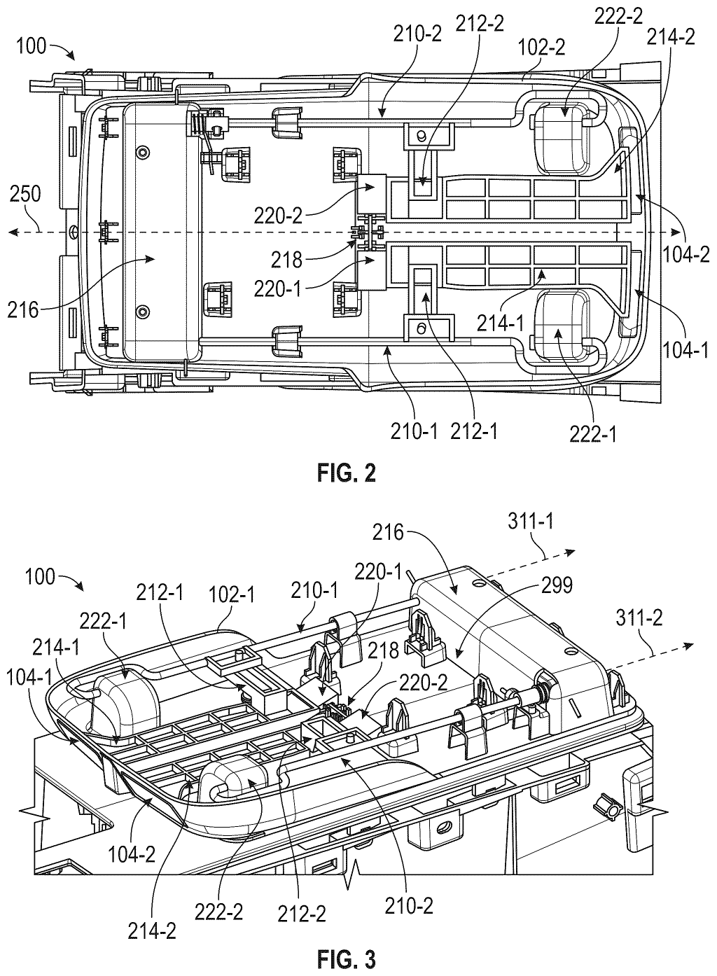

The body 102 preferably extends along a longitudinal axis 250 (See FIG. 2) from a first end to a second end. The body 102 further preferably includes a first button 104-1 disposed adjacent a second button 104-2 at the first end. The first end may also be referred to as a distal end. As shown in FIG. 1, the body 102 further preferably includes a projection 106 disposed between the first and second buttons 104-1, 104-2. The projection 106 preferably extends from the first end of the body 102. More preferably, the projection 106 extends from the body 102 further than the first and/or second buttons 104-1, 104-2.

The projection 106 can allow for a user to differentiate between the first and second buttons 104-1, 104-2. The projection 106 is preferably implemented as a fixed structure that does not actuate/depress based on a user-supplied force. However, the projection 106 may also be implemented as a button configured to receive a user-supplied force and cause a predetermined action such as, for example, energizing of a light within a vehicle, and/or opening of an additional storage compartment.

The first body portion 102-1 may also be referred to herein as a base portion or simply a base. The second body portion 102-2 may also be referred to herein as a top portion or a cover.

The first body portion 102-1 is preferably configured to couple to the second body portion 102-2 via, for example, clips 704 (See FIG. 7). The first and second body portions 102-1, 102-2 are further preferably configured to define a cavity 299 (See FIG. 3) therebetween when coupled to each other.

The second body portion 102-2 is further preferably configured to provide an armrest surface to support an arm of a vehicle occupant.

Turning specifically to FIGS. 2-3, the access door 100 is shown with the second body portion 102-2 removed for clarity.

As shown, the first and second buttons 104-1, 104-2 are coupled to respective locking arrangements and are configured to receive a user-supplied force to allow for opening of the access door 100 and access to a corresponding storage space. Preferably, the first button 104-1 is configured to cause the access door 100 to rotate in a first direction in response to actuation by a user, and the second button 104-2 is configured to cause the access door 100 to rotate in a second direction in response to actuation by a user. The first and second directions are preferably opposite each other.

In particular, the first button 104-1 is coupled to a first locking arrangement that includes a first actuator 214-1, a first linkage 212-1, and a first locking arm 210-1. The first locking arm 210-1 may also be referred to herein as a locking pin or a locking hinge member. The first button 104-1 is preferably coupled to a first end of the first actuator 214-1. The first actuator 214-1 is preferably configured to extend substantially parallel with the longitudinal axis 250 of the body 102. The first actuator 214-1 preferably couples to the first linkage 212-1 adjacent a second end of the first actuator 214-1. The first linkage 212-1 preferably pivotally couples with the first body portion 102-1 via a projection 708 (See FIG. 7). The first linkage 212-1 further preferably includes a spring member 710 (See FIG. 7) to supply a bias force in a direction that extends away from the first button 104-1. Preferably, the spring member 710 is configured to supply a bias force to the first locking arm 210-1 such that, in an absence of a user-supplied force to the first button 104-1, the first locking arm 210-1 is displaced in a direction away from the first button 104-1, e.g., to ensure the first locking arm 210-1 remains extending into the first lobe 502-1 to maintain the access door 100 in a closed position, such as shown in FIG. 5.

Note, the spring biasing of the first locking arm 210-1 can be used to “latch” the first locking arm 210-1 to the support structure when, for instance, a user desires to close the access door 100. In this example, the first locking cavity 222-1 can include a profile/contour that can engage the spring-biased first locking arm 210-1 and guide the same back into the aperture provided by the first lobe 502-1. Accordingly, a user may then simply provide a force sufficient to cause the access door 100 to rotate to a position where the spring-biased first locking arm 210-1 is aligned with the aperture of the first lobe 502-1 to “latch” the access door 100 in the closed position.

The first linkage 212-1 further preferably pivotally couples to the first locking arm 210-1. As further shown, the first button 104-1 preferably couples to the first locking arm 210-1 by way of the first linkage 212-1. Preferably, and as discussed above, the first linkage 212-1 pivotally couples to the body and to the first locking arm and is used to translate linear movement of the first button 104-1 to rotational movement. The rotational movement of the first linkage 212-1 is preferably configured to displace the first locking arm 210-1 and cause the first locking arm 210-1 to decouple from the first locking section of the support structure.

The first linkage 212-1 preferably includes a first end that at least partially extends into a first locking cavity 222-1 defined at least in part by the first body portion 102-1. The locking cavity 222-1 further preferably includes a profile that corresponds with a locking portion/section provided by the support structure 101. FIG. 5 illustrates the first locking cavity 222-1 as transparent to show the locking section of the support structure implemented as a first lobe 502-1. Preferably, the locking section of the support structure includes at least two of such lobes, such as the first and second lobes 502-1, 502-2. The locking section may also be referred to as a yoke. In this scenario, the first body portion 102-1 preferably includes first and second locking cavities 222-1, 222-2 to receive the first and second lobes 502-1, 502-2, respectively.

Continuing with FIGS. 2 and 3, and as discussed above, the first locking arm 210-1 preferably includes a first end that extends into the locking cavity 222-1 and at least partially into an aperture provided by the first lobe 502-1 (See FIG. 5). The first locking arm 210-1 further preferably extends substantially parallel with the longitudinal axis 250 of the body 102. A second end of the first locking arm 210-1 further preferably extends into spring housing 216 disposed adjacent the second end of the first body portion 102-1. The spring housing 216 preferably includes a spring-loaded member 504 (see FIG. 5) disposed therein. The second end of the first locking arm 210-1 preferably extends into a first opening 505-1 of the spring-loaded member 504 (See FIG. 5). Likewise, the second end of the second locking arm 210-2 preferably extends into a second opening 505-2 of the spring loaded member 504. The first and second openings 505-1, 505-2 of the spring-loaded member 504 are preferably disposed adjacent opposite ends of the spring-loaded member 504.

In the example of FIGS. 2-3, the first locking arm 210-1 defines a first rotational axis 311-1 when coupled to the first lobe 502-1 of the locking section provided by the support structure 101. The first rotational axis 311-1 preferably extends substantially parallel with the longitudinal axis 250 of the body 102. The body 102 preferably rotates about the first rotational axis 311-1 when the second locking arm 210-2 decouples from the second lobe 502-2. Likewise, the body 102 preferably rotates about the second rotational axis 311-2 when the first locking arm 210-1 decouples from the first lobe 502-1.

The second button 104-2 preferably couples to a second locking arrangement that includes a second actuator 214-2, a second linkage 212-2, and a second locking arm 210-2. The second locking arm 210-2 may also be referred to herein as a locking pin or a locking hinge member. The second locking arrangement can be configured substantially identical to the first locking arrangement coupled to the first button 104-1 as discussed above, the description of which will not be repeated for brevity.

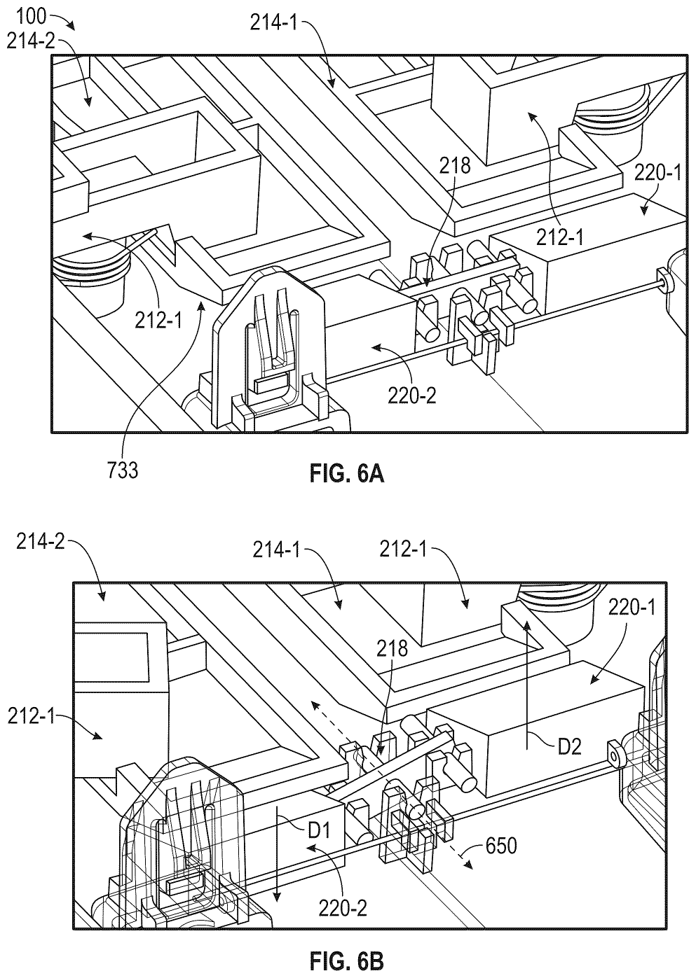

As further shown in FIGS. 2-3, the body 102 further includes first and second stops 220-1, 220-2 disposed therein. The first and second stops 220-1, 220-2 are preferably coupled together/adjoined via pivot arm 218. The pivot arm 218 is preferably configured to rotate about a third rotational axis 650 (See FIG. 6B) that extends substantially parallel relative to the longitudinal axis 250 of the body 102. Each of the first and second stops 220-1, 220-2 preferably include a blocking surface and a toggle surface.

For example, and as shown more clearly in FIG. 7, the first stop 220-1 includes a blocking surface 714 and a toggle surface 716 that extends from the blocking surface 714 at a predetermined angle. The predetermined angle of the blocking surface 714 relative to the toggle surface is preferably 45±20 degrees, and more preferably 45±10 degrees.

As more clearly shown in FIG. 6A, each of the first and second actuators 214-1, 214-2 include an end with a tapered section that is disposed adjacent the first and second stops 220-1, 220-2, respectively. The tapered section of each actuator preferably defines an angled surface at a distal end, e.g., angled surface 733 (See FIG. 7). The angled surface of each arm is preferably configured to slidably engage a corresponding toggle surface of the first and second stops 220-1, 220-2.

For example, and as shown in FIG. 6B, the angled surface of the second actuator 214-2 is preferably configured to slidably engage the toggle surface of the second stop 220-2, e.g., based on actuation of the second button 104-2 by a user. In response, the second stop 220-2 is displaced vertically along a first direction D1, and thus by extension, causes the pivot arm 218 to rotate about the third rotational axis 650. The rotation of the pivot arm 218 then preferably displaces the first stop 220-1 vertically along a second direction D2, with direction D2 being opposite the direction D1. In this position, the first stop 220-1 includes blocking surface 714 (See FIG. 7) aligned with the first actuator 214-1 in a blocking orientation. The blocking orientation preferably includes an end of the first actuator 214-1 (directly) abutting the blocking surface of the first actuator 214-1 such that an attempted actuation of the first button 104-1 by a user causes the first actuator 214-1 to bottom out against the blocking surface. Accordingly, and in this scenario, the angled surface of the first actuator 214-1 is prevented from slidably engaging the toggle surface of the first stop 220-1.

Thus, in this preferred example, an access door consistent with the present disclosure can allow for a user to actuate the first button 104-1 or the second button 104-2 to cause the access door to rotatably open in a desired direction. In addition, actuation of the first button 104-1 then prevents/blocks inadvertent actuation of the second button 104-2, and vice-versa. Advantageously, this ensures that at least one of the aforementioned locking arrangements disposed on opposite sides of the access door remains coupled to a corresponding locking section of the support structure that underlies the access door, i.e., in the locked orientation, to provide a hinge as discussed above.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. It will be appreciated by a person skilled in the art that an apparatus may embody any one or more of the features contained herein and that the features may be used in any particular combination or sub-combination. Modifications and substitutions by one of ordinary skill in the art are considered to be within the scope of the present disclosure, which is not to be limited except by the claims.

What is claimed is:

1. An access door for a storage compartment within a vehicle, the access door comprising:
a body to rotatably couple to a support structure of the vehicle to removably cover the storage compartment;
a first locking arm disposed within the body and configured to removably couple to a first locking portion of the support structure, the first locking arm configured to define a first axis of rotation;
a second locking arm disposed within the body and configured to removably couple to a second locking portion of the support structure, the second locking arm configured to define a second axis of rotation;
a first button disposed at an end of the body, the first button coupled to the first locking arm and configured to cause the first locking arm to decouple from the first locking portion of the support structure based on receiving a user-supplied force and allow the body to rotate about the second axis of rotation in a first direction via the second locking arm; and
a second button disposed at the end of the body, the second button coupled to the second locking arm and configured to cause the second locking arm to decouple from the second locking portion of the support structure based on receiving a user-supplied force and allow the body to rotate about the first axis of rotation in a second direction via the first locking arm.

2. The access door of claim 1, wherein the body comprises an armrest surface to support an arm of an occupant of the vehicle.

3. The access door of claim 1, wherein the body extends from a first end to a second end along a longitudinal axis, and wherein the first and second button are disposed at the first end.

4. The access door of claim 3, further comprising a projection extending from the first end of the body, the projection being disposed between the first and second buttons.

5. The access door of claim 3, wherein the first and second locking arms extend substantially parallel with each other and with the longitudinal axis of the body.

6. The access door of claim 3, wherein the first locking arm includes a first end to removably couple to the first locking portion of the support structure adjacent the first end of the body, and wherein the second locking arm includes a first end to removably couple to the second locking portion of the support structure adjacent the first end of the body.

7. The access door of claim 6, wherein the first locking arm includes a second end coupled to a spring-loaded member, the spring-loaded member to provide a bias force in the second direction.

8. The access door of claim 7, wherein the second locking arm includes a second end coupled to the spring-loaded member, the spring-loaded member to provide a bias force in the first direction.

9. The access door of claim 1, wherein the first button couples to the first locking arm by way of a first linkage, and wherein the first linkage pivotally couples to the body and to the first locking arm, the first linkage to translate linear movement of the first button to rotational movement, the rotational movement configured to displace the first locking arm and cause the first locking arm to decouple from the first locking portion of the support structure.

10. The access door of claim 9, wherein the first linkage includes a spring member configured to supply a bias force to the first locking arm such that, in an absence of a user-supplied force to the first button, the first locking arm is displaced in a direction away from the first button.

11. The access door of claim 9, wherein the second button couples to the second locking arm by way of a second linkage, and wherein the second linkage pivotally couples to the body and to the second locking arm, the second linkage to translate linear movement of the second button to rotational movement, the rotational movement configured to displace the second locking arm and cause the second locking arm to decouple from the second locking portion of the support structure.

12. The access door of claim 11, wherein the second linkage includes a spring member configured to supply a bias force to the second locking arm such that, in an absence of a user-supplied force to the second button, the second locking arm is displaced in a direction away from the second button.

13. The access door of claim 1, further comprising first and second stops disposed in the body and a pivot arm adjoining the first and second stops, the pivot arm coupled to the body and configured to rotate about a third axis of rotation, the third axis of rotation being substantially parallel to the first and second axis of rotation.

14. The access door of claim 13, wherein the first button is configured to engage the first stop based on a user-supplied force and cause the pivot arm to rotate about the third axis of rotation and transition the second stop to a blocking orientation, the blocking orientation to prevent actuation of the second button by a user from causing the second locking arm to decouple from the second locking portion.

15. The access door of claim 14, wherein the first and second stops each include a blocking surface and a toggle surface that extends at a predetermined angle relative to the blocking surface.

16. The access door of claim 1, wherein the first locking arm provides a hinge to allow for the access door to rotate about the first axis of rotation in the first direction based on a user-supplied force to the second button, and wherein the second locking arm provides a hinge to allow for the access door to rotate about the second axis of rotation in the second direction based on a user-supplied force to the first button, and wherein the first and second directions are opposite each other.

17. An armrest for use in a vehicle, the armrest comprising:
a body to couple to a support structure within a vehicle and provide a cover for a storage compartment within the vehicle;
first and second buttons disposed adjacent each other at an end of the body;
first and second locking hinge members disposed in the body and coupled to the first and second buttons, respectively, each of the first and second locking members to removably couple to a locking portion provided by the support structure; and
wherein the first button is configured to receive a user-supplied force and cause the first locking hinge member to decouple from the locking portion and allow for rotation of the body relative to the support structure based on the second locking hinge member.

18. The armrest of claim 17, wherein second button is configured to receive a user-supplied force and cause the second locking hinge member to decouple from the locking portion and allow for rotation of the body relative to the support structure based on the first locking hinge member.
